(19) United States
(12) Patent Application Publication
(10) Pub. No.: US 2009/0090232 A1
(43) Pub. Date: Apr. 9, 2009

(54) BELL STRING DECORATION ASSEMBLY

(76) Inventor: Tsung-Wei Chen, Changhua City (TW)

Correspondence Address: RABIN & BERDO, P.C., Suite 500, 1101 14th Street, Washington, DC, 20005, US

(21) Appl. No.: 11/867,868

(22) Filed: Oct. 5, 2007

(51) Int. Cl. G10K 1/10

(52) U.S. Cl. 84/406

(57) ABSTRACT

This invention provides a bell string decoration assembly, and different sized bells are connected appropriately into a string, and colors of the bells are arranged to give a special stylish decoration. The assembly is made by passing at least two metal wires through a hanging portion of each bell and bending the wires into halves and twisting appropriately into a multiple of wires. The wires are used for connecting the bells into a string and then the bells are collectively twisted and fixed to complete connecting each layer of bells sequentially. With a variation of number and size of the bells at each layer, and an appropriate arrangement of colored bells a special stylish bell string decoration. In addition to connecting each layer of the bells into a string, the invention also provides appropriately sufficient moving spaces, such that the bells can be swung or twisted freely.

### BACKGROUND OF THE INVENTION

1. Field of the Invention

The present invention relates to a bell string decoration assembly, and more particularly to an assembly that uses at least two metal wires to connect a number of bells into a string, and after the wires are passed through each layer of bells, the wires are twisted into knots to connect the bells in a string and separate each layer of bells, the invention also provides sufficient moving space for each layer of bells, such that the bells can be swung or twisted freely.

2. Description of the Related Art

In general, decorations with bells usually do not adopt bells as the main stylish design, but appropriate accessories are used to go with different stylish main bodies to give the desired visual decorative effect and pleasant sound to give more fun to the bell decoration when the bell decoration is hung.

At present, bell decorations adopting bells as the main stylish bodies are seldom found. Although some manufactures attempt to connect several bells into a string, yet the bells are connected directly by a wire, and such arrangement has no stylish design at all, and is considered simply as a decoration accessory and definitely not a mainstream decorative item.

In view of the shortcomings of the prior art, the inventor of the present invention conducted extensive researches and experiments, and finally developed a bell string decoration assembly in accordance with the invention, such that the assembly uses bells as a main body for designing various stylish hanging decorations. With a variation of size and color of the bells, different stylish designs of bell decorations can be achieved, a new business opportunity is created, and more choices for purchasing a product are provided to consumers

### SUMMARY OF THE INVENTION

The primary objective of the present invention is to provide a bell string decoration in the hope of giving different styles for the hanging decoration by the specific features of the bells, so that the bells become a main body of the hanging decoration instead of an accessory. The invention not just connects a plurality of bells into a straight string only, but also connects the bells of different sizes at different layers to provide a visual effect that looks like a bunch of grapes Further, different colors are arranged to give more variations to the overall stylish design Unlike traditional designs of a hanging decoration, the invention can greatly improve the industrial value of the bells.

### BRIEF DESCRIPTION OF THE DRAWINGS

FIG. 1 is a schematic view of an assembly of a preferred embodiment of the present invention;

FIG. 2 is a schematic view of an assembly at the beginning of connecting bells in accordance with a preferred embodiment of the present invention;

FIG. 3 is a schematic view of an assembly during the process of connecting bells in accordance with a preferred embodiment of the present invention;

FIG. 4 is a schematic view of an overall assembly in accordance with a preferred embodiment of the present invention;

FIG. 5 is a schematic view of an assembly in a swinging motion in accordance with a preferred embodiment of the present invention;

FIG. 6 is a schematic view of a preferred embodiment of the present invention;

FIG. 7 is a schematic view of another preferred embodiment of the present invention; and

FIG. 8 is a schematic view of a further preferred embodiment of the present invention.

### DETAILED DESCRIPTION OF THE PREFERRED EMBODIMENTS

The structure, technical measures and effects achieved by the present invention will become apparent in the detailed description of the preferred embodiments with reference to the accompanying drawings as elaborated below.

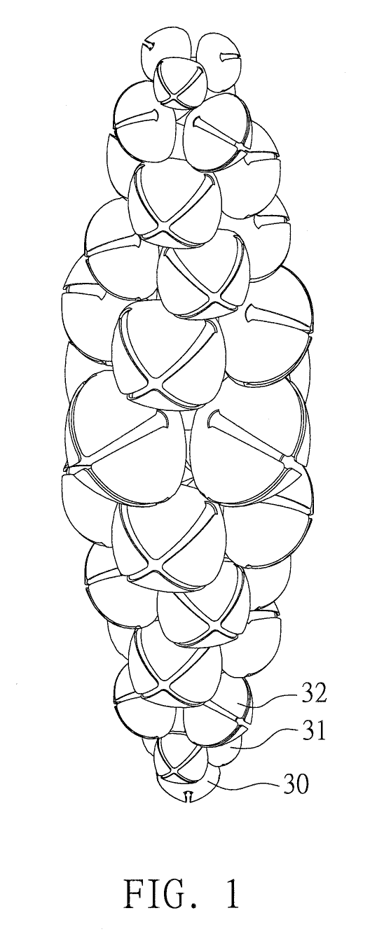

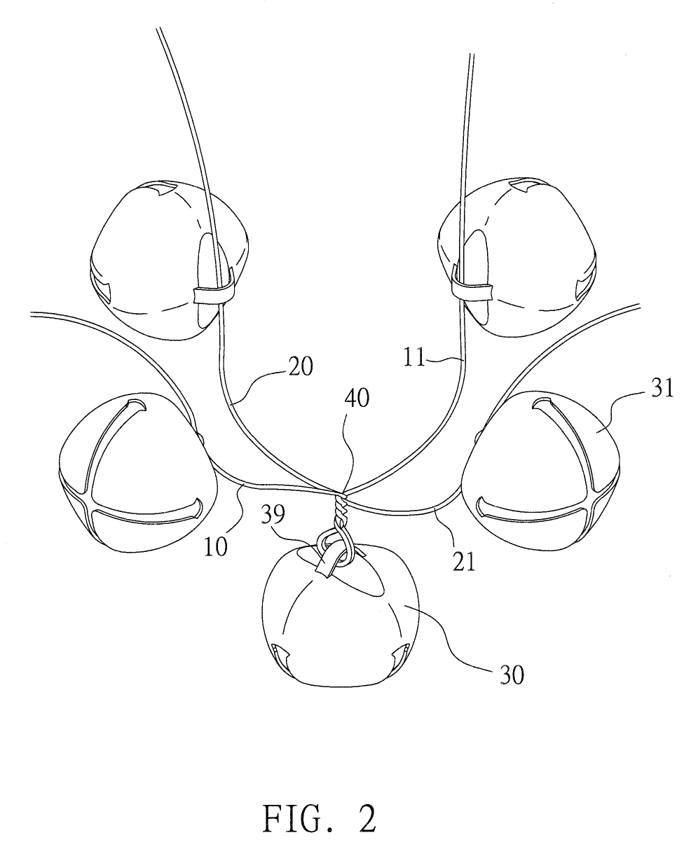

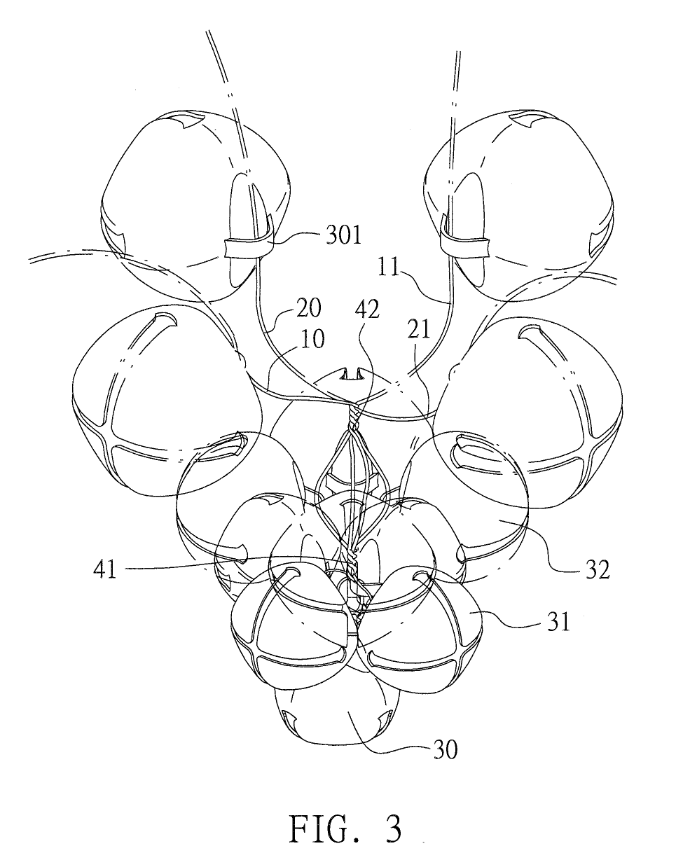

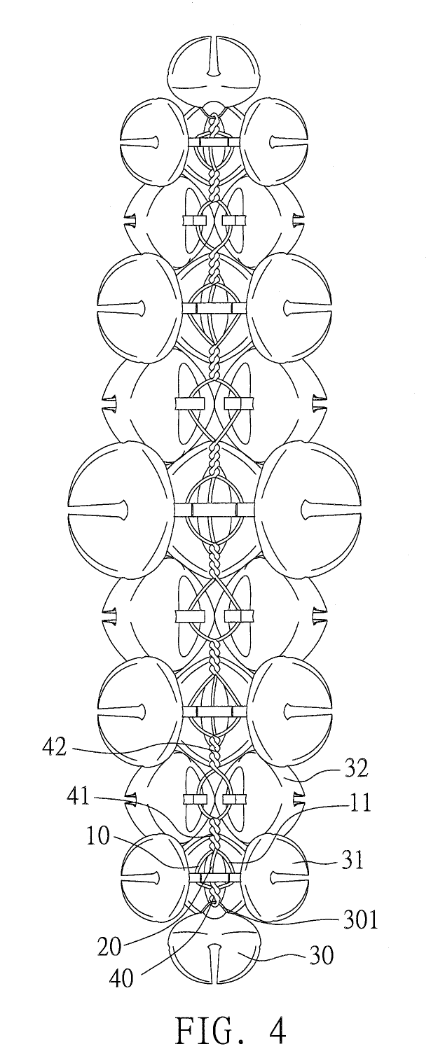

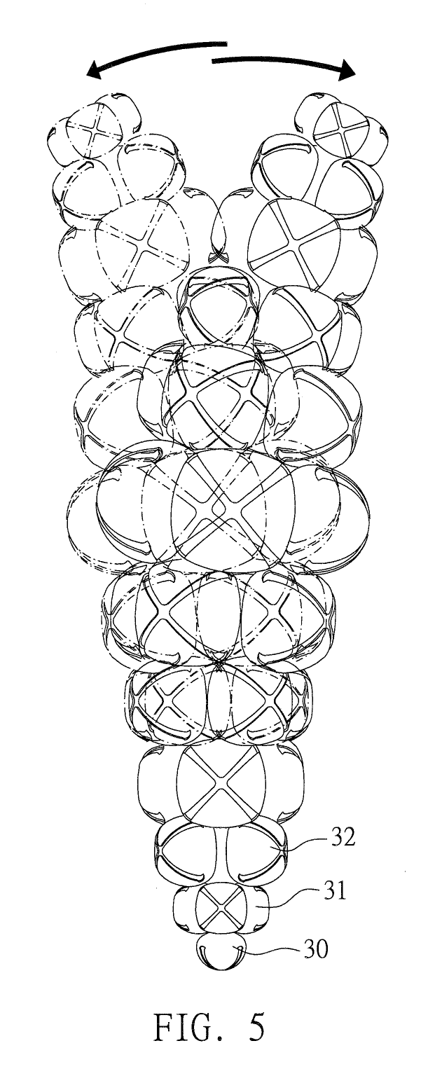

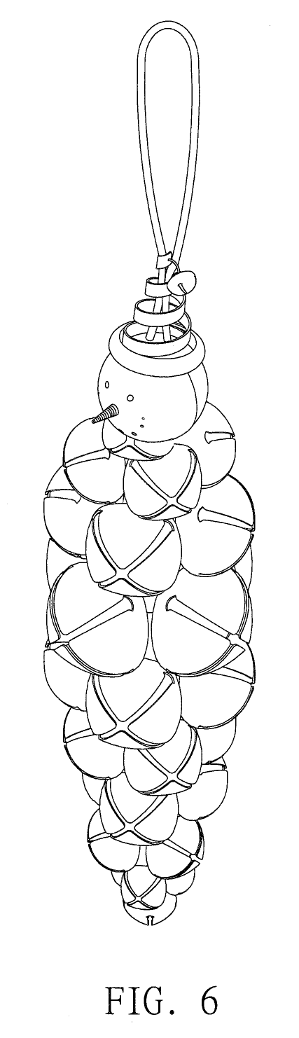

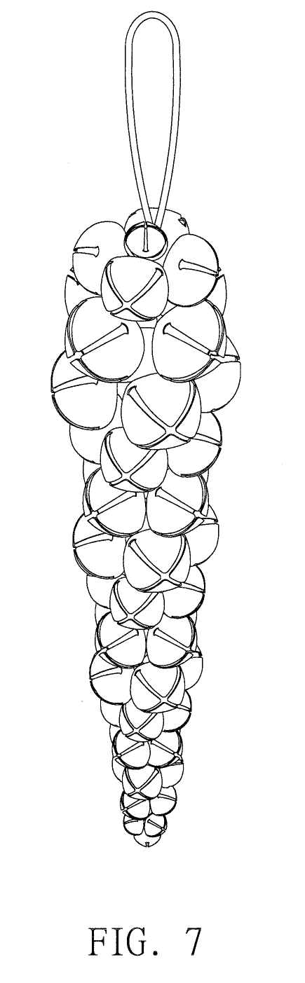

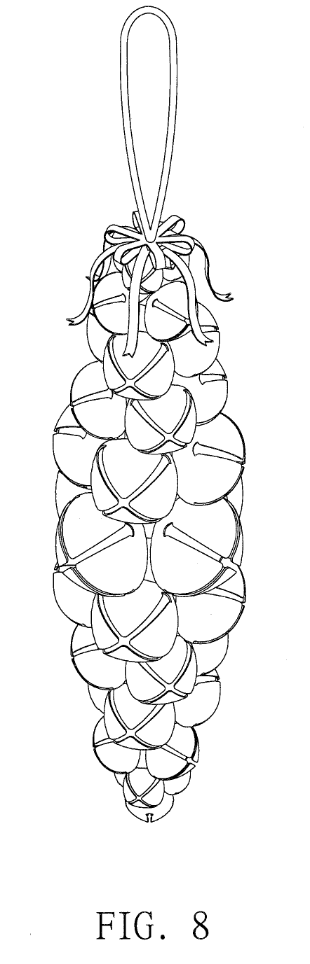

Referring to FIGS. 1 to 3 for schematic views of an assembly of the invention, FIG. 4 for a schematic view of a structural relation of an assembly of the invention, FIG. 5 for a schematic view of motions of an assembly of the invention, and FIGS. 6 to 8 for preferred embodiments of the invention respectively, the structural design of the bell string decoration assembly has at least two metal wires 10, 20 used as a component for connecting a plurality of bells 30 into a string, and the bells 30 can be of different colors and sizes, and the top of each bell 30 has an integrally punched hanging portion 301 provided for passing and connecting the metal wires 10, 20 to form the bell string decoration in accordance with the present invention.

In the connection process, a plurality of metal wires 10, 20 are passed simultaneously through a hanging portion 301 of each bell 30 that serves as a basic decoration, and then the metal wires 10, 20 are folded into halves to double the number of metal wires 10, 11, 20, 21. Meanwhile, the metal wires 10, 11, 20, 21 are twisted into a knot to form a position limit connection portion 40 for fixing the bell 30 appropriately to prevent any unintentional slides. Further, the metal wires 10, 11, 20, 21 are used for passing a plurality of bells 31. During the connection process, a metal wire 10, 11, 20, 21 is primarily used for passing a bell 31. If the number of bells 31 is smaller than the number of metal wires 10, 11, 20, 21, then two or more metal wires 10, 11 may be used simultaneously for connecting a bell 31. After the metal wires 10, 11, 20, 21 are passed through the layer of bells 31, the wires are also twisted in to a knot to form a limit position connection portion 41 to fix the layer of bells 31 appropriately, and then the metal wires 10, 11, 20, 21 are used for continuing the connection of the next layer of bells 32. Similarly, after the metal wires 10, 11, 20, 21 complete the connection of the layer of bells 32, the metal wires 10, 11, 20, 21 are twisted into a knob appropriately to form another limit position portion 42 for fixing the bell 32, so that a plurality of layers of bells 30, 31, 32 can be connected sequentially into a string. The number of layers and the number of bells 30, 31, 32 can be changed to constitute different bell string decoration assemblies.

In the connection process of the bell string decoration, different sized bells 30 may be used for the installation to give various stylish designs. Further, the colors of each layer of bells 30, 31, 32 can be arranged to give different stunning visual effect in a spiral form, and thus greatly improving the overall aesthetic visual effect of the bell string decoration. Various accessories such as a clown head or a decorative tape can be added, if necessary, to go with the bell string decoration assembly, so as to give more variations to the overall stylish configuration and break through the designs and bottlenecks of traditional bell decorations. Obviously, the present invention has industrial values.

Further, the bell string decoration twists the metal wires 10, 11, 20, 21 into knots at each layer of bells 30, 31, 32 to give an appropriate fixing effect, which provides sufficient moving spaces for the bells. If the bells 30, 31, 32 are connected too tight, then the bells cannot be moved freely. If the knots are arranged appropriately, each layer of bells 30, 31, 32 can have sufficient moving space, so that the bell string decoration can have better swinging and twisting effects. With the color arrangement of the bells 30, 31, 32, the overall design can give a unique moving visual effect.

In view of the description above, the structural design of the bell string decoration in accordance with the present invention uses at least two metal wires to connect the bells into a string. With different sizes and colors of the bells, a unique visual effect is achieved, and the knots of the wires used for fixing each layer of bells not only maintain the connection of bells in a string, but also provide appropriate swinging and twisting effects, so that the overall design is more aesthetic and outstanding. Obviously, the invention breaks through the bottlenecks of transitional bell decorations.

In summation of the description above, the design of the bell string decoration connects different sized bells appropriately into a string and arranges the colors of the bells to constitute a special stylish hanging decoration. Overall speaking, the invention is in compliance with the requirements of patent application, and is thus duly filed for patent application.

What is claimed is:

1. A bell string decoration assembly, comprising:
at least two metal wires, served as a bell connecting component; and
a plurality of bells, with various different size, and having a hanging portion disposed at the top of a bell for passing and connecting the metal wires; such that when the bells are installed, the plurality of metal wires are passed through a hanging portion of each bell which serves as a basic decoration, and folded into halves and twisted appropriated into a multiple number of wires, and the wires are used for passing the plurality of bells, and the bells are connectively and appropriately fixed into their positions to form position-limit portions, so that each layer of bells can be connected and fixed sequentially, and a bell string decoration of various stylish designs can be achieved by varying the number of bells at each layer and the size of the bells.

2. The bell string decoration assembly as recited in claim 1, wherein the bells are of different colors for providing various different visual patterns by arranging the colors of the bells.

3. The bell string decoration assembly as recited in claim 1, wherein the bells at each layer are separated and limited in position by a twisting structure of the metal wire and the bells of each layer can be movably swung, and twisted.

4. The bell string decoration assembly as recited in claim 1, wherein the bell string decoration includes an appropriate installation of various accessories to provide more variations of the overall stylish configuration of the bell string decoration.
